(19) United States
(12) Patent Application Publication
(10) Pub. No.: US 2014/0084716 A1
(43) Pub. Date: Mar. 27, 2014

(54) ROTATING ELECTRICAL MACHINE WITH SO-CALLED DOUBLE HOMOPOLAR STRUCTURE

(71) Applicant: Francois Bernot, Luynes (FR)

(72) Inventor: Francois Bernot, Luynes (FR)

(73) Assignee: SINTERTECH, Veure-Voroize (FR)

(21) Appl. No.: 13/996,912

(22) PCT Filed: Dec. 20, 2011
(86) PCT No.: PCT/FR2011/053071

§ 371 Date: Dec. 5, 2013

(30) Foreign Application Priority Data
Dec. 21, 2010 (FR) 10 60923

(51) Int. Cl. H02K 1/24; H02K 31/00

(52) U.S. Cl. CPC H02K 1/246; H02K 31/00
USPC 310/46; 310/178

(57) ABSTRACT

Homopolar electric machine, characterized in that its structure is double, its rotor and its stator being simultaneously homopolar, and in that it includes a stack of pairs of simple homopolar stators, forming monophasing elementary machines, or in a reverse version, the elementary machines being powered with AC current; the rotor is common to all these stators, and is passive, that is to say composed completely or partially of ferromagnetic materials.

The invention relates to a rotating electrical machine with a “double” homopolar structure. In particular, it concerns a rotating electrical machine comprising a stator and a rotor turning about the same axis of rotation as the stator, housed in a body, at least the stator or the rotor comprising at least one annular field coil supported by a magnetic annular yoke comprising at least two poles angularly shifted by an equal distance from each other, these poles being formed by brackets secured to said annular yoke and folded parallel to said axis.

It is known that there exist two classes of homopolar machines:
homopolar stator machines, where the stator consists of independent phases each forming a homopolar machine powered by AC, and where the rotor has the conventional coplanar structure;
homopolar rotor machines, where the stator has the conventional coplanar structure and the rotor has a homopolar structure, with its magnetization winding physically connected to the stator and powered by DC.

Prior Art of Simple Homopolar Stator Machines Powered by AC

As an example, patent applications FR 2 809 240 and FR 2 828 027 disclose the structure and operation of an electrical machine with a simple homopolar stator. In addition, patent applications FR 10 01805, FR 10 01806 and FR 10 01807 disclose improved simple homopolar machines which have an AC-powered homopolar stator and a coplanar rotor.

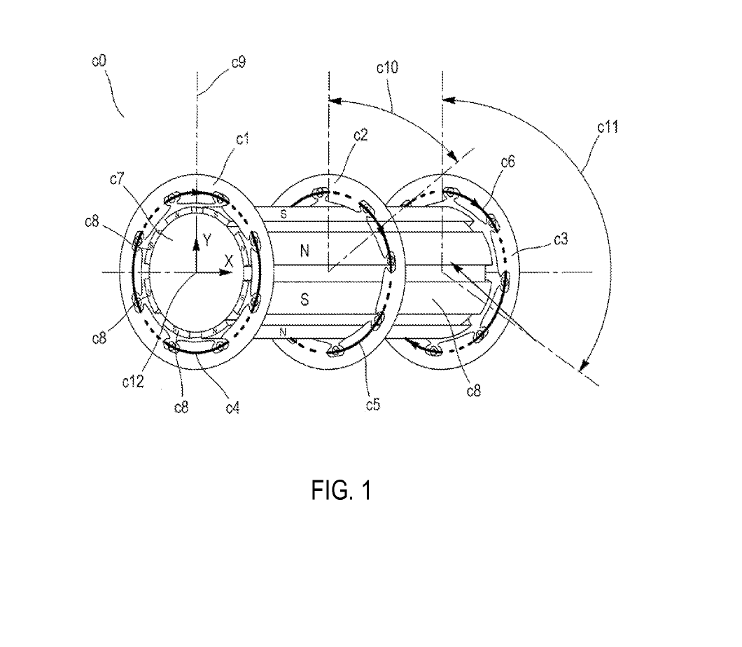

FIG. 1 shows the prior art for this simple homopolar structure, in a version with eight poles, with a three-phase claw-pole stator and a rotor with surface magnets. It should be noted that:
another version can include a rotor with embedded magnets;
another version can include a multiphase stator, with any number of phases (greater than or equal to one);
another version can include a reversed external rotor.

The embodiment in FIG. 1 contains three identical stators c1, c2 and c3, forming a simple three-phase homopolar machine c0. Said stators c1, c2 and c3 will be referred to in this document as phases when they are complete with their coil c4, c5 or c6. These wafers are have their phases offset relative to one another by a mechanical angle of about 30°. In the embodiment shown in FIG. 1, the angle c10 is substantially 30° and the angle c11 is substantially 60°. The angle c10 substantially corresponds to a third of the electrical angle of the rotating machine, said electrical angle being equal to 360° (one turn) divided by the number of pairs of poles (four in this octopolar case). The angle c11 is substantially twice the angle c10.

These angular offsets may differ depending on the applications, but such variations fall within the known prior art, particularly as applied to other rotating machine structures. They are only used to optimize the final machine. A two-phase version of said machine would only include two stators c1 and c2, which would then be offset by an angle c10=45° in the octopolar embodiment described in FIG. 1. The rules for calculating the angular offsets between phases or respective stators are part of the prior art. In a multiphase version, generally the number of power supply phases is at least equal to the number of phases c1, c2, c3.

In the embodiment in FIG. 1, the stators c1, c2 and c3 have a claw structure, which is characterized by an apparent undulation of the stator coils, denoted respectively c4, c5 and c6, around the planes of rotation X/Y c12 of each stator. Said undulation may be obtained by twisting the stator teeth, as disclosed in patent FR 2 809 240, or by encircling the coils c4, c5 and c6, as disclosed in patent FR 2 828 027.

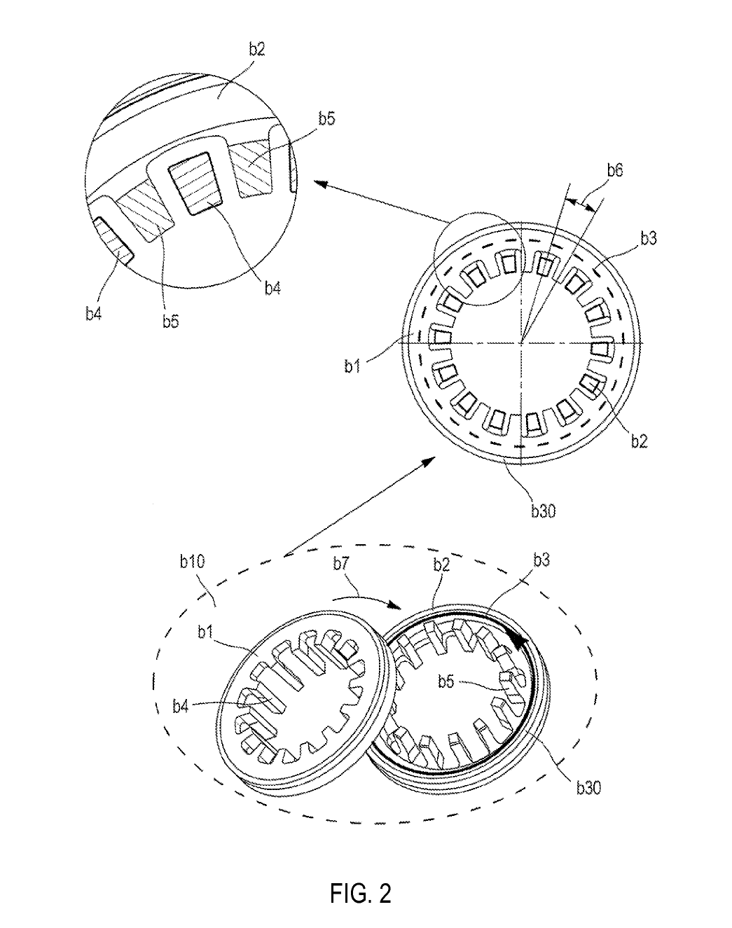

In the latter ingenious embodiment, shown in FIGS. 1 and 2, for a number of poles equal to 28, the stators c1, c2 and c3 are all made in the same way b10, from two identical wafers b1 and b2 clasping a coil b3. Said wafers are assembled together according to the teachings of patent FR 2 828 027, so that their respective teeth b4 and b5 are substantially equidistant. Wafer b1 is placed on wafer b2, as indicated by the arrow b7. The contact areas b30 between the wafers b1 and b2 must be properly implemented in order to avoid undesirable magnetic gaps in the contact area. The shape of this contact area b30 may possibly not consist of a coplanar plane along X/Y c12, but may adopt any other form such as an undulation or crenellation, which would allow fixing the relative angular positions of said wafers b1 and b2. Wafer b2 is angularly offset relative to wafer b1. Said fixed angle b6 in the case of the stator of FIG. 2 is substantially half the electrical angle of the machine, i.e. for this polarity of 14 pairs of poles shown in FIG. 2, the value: 12.857°.

It is important to note that in the embodiments in FIGS. 1 and 2, each tooth b4 and b5 forms a complete electrical pole of the machine. Therefore in FIG. 1 we have an assembly of single-phase rotating electrical machines, axially joined about a same rotor c7. Said rotor may be of several types: synchronous, asynchronous, or variable reluctance. The various embodiments currently known for rotors are part of the prior art, and are all adaptable to the presence of a set of claw-pole stators as described in FIG. 1.

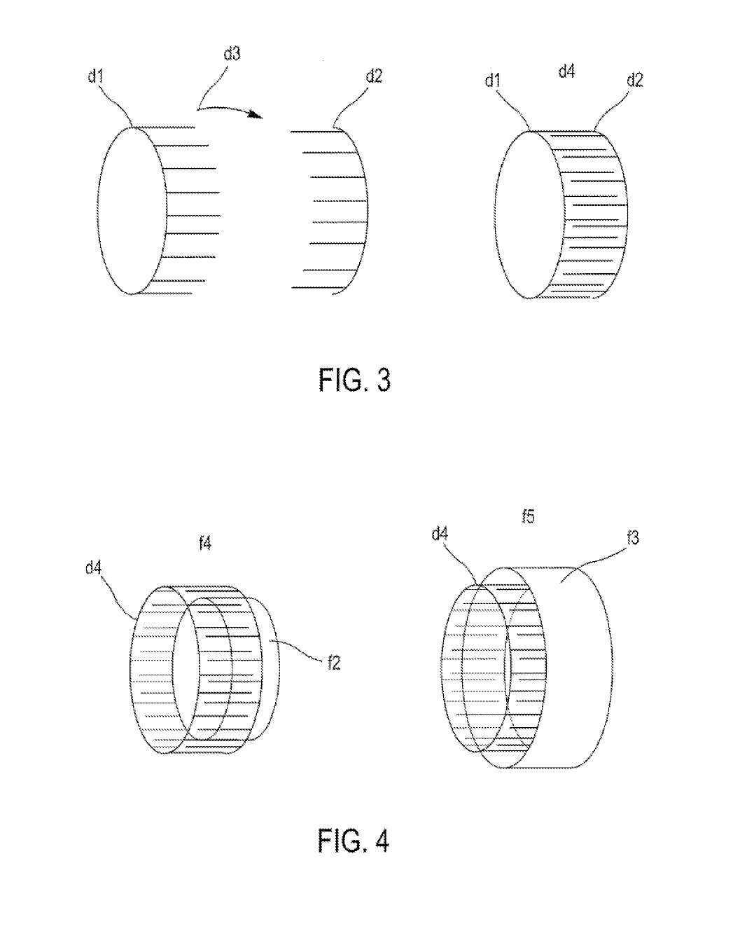

In the rest of this document, the stators c1, c2, and c3 will be referred to using the word “phase”, in order to clarify their role. In the entire description which follows, we therefore consider the assembly formed by two wafers b1 and b2, clasping a coil b3, as a complete phase. FIG. 3 illustrates a more summary view of this proposal, showing the two wafers d1 for b1, and d2 for b2, which are joined together in the direction d3 to form a single phase d4, as described above b10, corresponding to the joining of two wafers b1 and b2 surrounding a coil b3. At this point in the description of the prior art, the benefit of providing a means of axially holding the wafers b1 and b2 together should be noted, which may for example consist of an elastic clamping washer, mounted at any location on the axis of rotation of the plane XY c12.

All these descriptions of the devices represented in FIGS. 1 and 2 are part of the prior art. They include the reversed stator version, where the teeth b4 and b5 of the wafers b1 and b2 are located on the outer periphery, with a rotor which is located outside the stator.

The prior art clearly shows the interchangeability of the various elements of a rotating electrical machine, particularly their internal or external relative positions, as represented in FIG. 4. Phase d4, comprising two wafers d1 and d2, can be located outside a part f2, thus forming a single-phase homopolar rotating machine f′4. Phase d4, comprising two wafers d1 and d2, can be located inside a part f3, thus forming a single-phase homopolar rotating machine f5. The axial juxtaposition of these complete machines f4 or f5, offset by an appropriate angle, as is known from the prior art described above, forms a multiphase rotating machine.

As is represented in FIG. 4, the parts d4, f2 and f3 may be static or rotating. If a part d4 is rotating, it then must be powered by rings or by any other system know to a person skilled in the art (rotating diodes for example).

The combination of static part d4 and rotating magnets f2 (or coil inductor) corresponds to a machine f4 forming a synchronous machine. Phase d4 is then AC-powered according to brushless control methods known to a person skilled in the art.

The combination of static part d4 and rotating magnets f3 (or coil inductor) corresponds to a machine f5 forming a reversed synchronous machine. Phase d4 is then AC-powered according to known brushless control methods.

The combination of static f3 and rotating d4 parts corresponds to a machine f5 forming a claw-pole alternator, called a Lundell alternator, widely used in heat engines.

All other combinations are possible, such as rotating d4 and static f2 parts, or rotating d4 and static f3 parts, or both parts d4 and f2 rotating, or both parts d4 and f3 rotating. These different combinations are widely described in the prior art for rotating machines of coplanar structure.

The following non-exhaustive list groups various possible alternative applications of the invention in a rotating electrical machine:
synchronous machine with magnet rotor or coil rotor;
synchronous machine with magnet rotor created with plasto-magnets, i.e. formed from a magnetic powder impregnated with resin;
asynchronous machine with cage rotor or coil rotor;
variable reluctance machine, with passive or active (magnetized) rotor.

The following non-exhaustive list groups various possible alternative embodiments of the invention for forming a rotating electrical machine:
the relative arrangement of the different parts d4, f2 and f3, in order to form a machine of type f4 or f5, results in a machine with external stator or internal stator, referred to as “reversed”;
a single-phase, two-phase, three-phase, or multiphase machine, obtained by axially stacking elementary machines f4 or f5 with their phases properly offset relative to each other by an electrical angle substantially equal to one electrical turn (360° divided by the number of pairs of poles) divided by the number of phases, said angular phase offset possibly being created at the rotor or at the stator;
a multiphase machine, comprising at least one phase, where each electrical phase comprises several elementary machines f4 or f5 electrically connected serially or electrically in parallel;
a multiphase machine, comprising at least one phase, where the phases d4 are all angularly aligned and where the inter-phase displacement is caused by the rotation, at the rotor, of either the magnets or the coil inductors or the polar projections or the conductors of the supplemental part f2 or f3;
a multiphase machine, comprising at least one phase, where the coils b3 are divided into several distinct windings which are coupled from one phase to another in a zig-zag, star, or triangle pattern to form a complete multiphase machine;
the assembly can also form a static transformer, in which, as all the parts d4, f2 and f3 are static, they form a static phase shifter.

Prior Art for DC-Powered Homopolar Rotor Machines

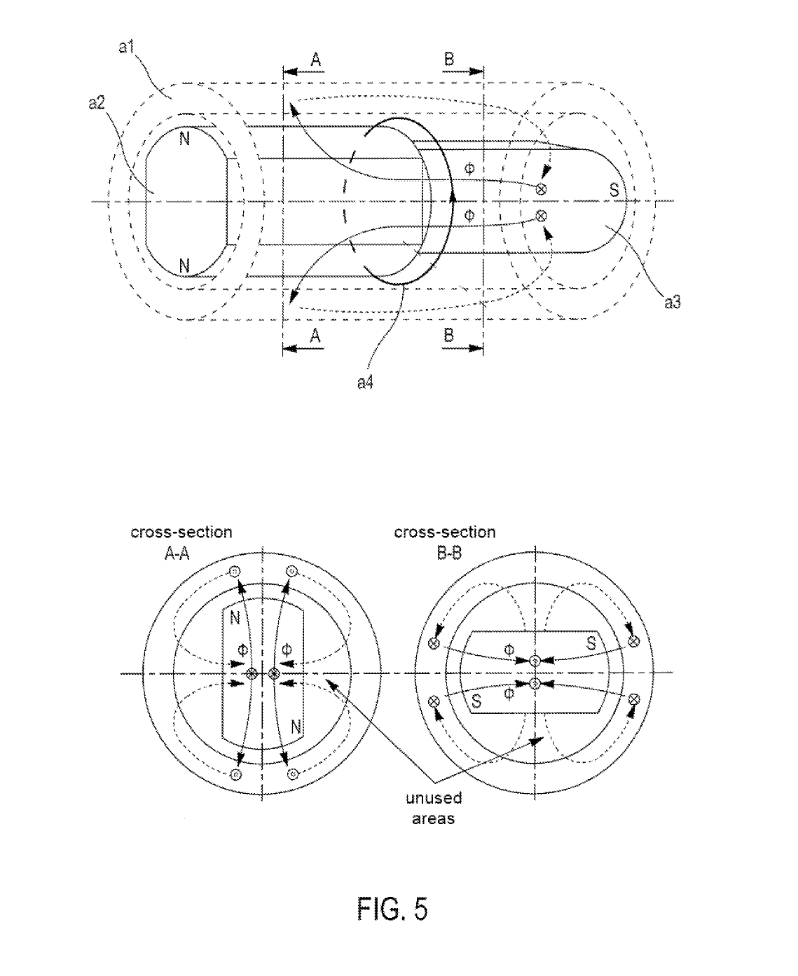

FIG. 5 represents the conventional structure of the homopolar rotor machine, in which a tetrapolar coplanar multiphase stator a1 is placed around a rotor separated into two half-rotors a2 and a3, angularly offset relative to each other by a mechanical 90°. The rotor excitation coil a4 is located in the median plane where the two half-rotors a2 and a3 meet. Once supplied with direct current, said coil a4 generates a magnetic flux denoted φ, which passes radially through the air gap separating the rotor from the stator facing the areas denoted S on the rotor a3 side and facing the areas denoted N on the rotor a2 side. As a result, half the conductors of the stator a12 receive no rotor magnetic flux and therefore do not contribute to the generation of drive torque.

The use of this type of machine has therefore been restricted to specific applications, for example where the rotor must turn very quickly, or where the ambient operating temperature is incompatible with conventional coil technologies. The most noteworthy application of this technology consists of a cryogenic machine, where the ceramic winding cannot withstand rotation.

In general, the main deficiency of these homopolar structures is that they provide half the torque that a similar coplanar machine could provide. This is the primary reason for their limited use in industry.

The present invention, which provides a solution to these problems, concerns an electrical machine which is a “double” homopolar motor e0, meaning the rotor and the stator are simultaneously homopolar.

More specifically, this motor type of electrical machine comprises a stack of pairs of simple homopolar stators b10/d4, forming single-phase elementary machines f4, or f5 in a reversed version. These elementary machines are AC-powered. The rotor e15 is common to all these stators and it is passive, meaning it consists wholly or partially of ferromagnetic material. Rotor excitation may be active in a first embodiment which involves a coil e2, preferably annular and fixed. Rotor excitation may be passive in another embodiment which involves at least one annular magnet, preferably fixed, replacing the assembly formed by the ferromagnetic part e1 and the coil e2.

The ultimate configuration of the so-called double structure homopolar motor e0 concerns all variants f4/f5 represented in FIG. 4, as well as those not mentioned which fall under the prior art.

It is apparent that when the inductor rotor a2/a3, generating a direct magnetic flux, of a motor becomes homopolar, on each side of a median line receiving the excitation coil a4, one out of two poles becomes inactive on each side of the machine a2 and a3. The same principle is applied to the invention described in this document, as an evolution of the simple homopolar version d4/b10 where the rotor contains as many poles as the stator has teeth e16.

One embodiment of the device according to the invention will be described below in a non-limiting example, with reference to the attached drawings in which:

FIG. 1 is a schematic representation of a simple homopolar electrical machine of the prior art, in an eight-pole version with a three-phase claw-pole stator and a rotor with surface magnets.

FIG. 2 is a schematic representation of the stators of the electrical machine represented in FIG. 1.

FIG. 3 is a schematic representation of the stators or phases each consisting of an assembly formed of two wafers clamped around a coil.

FIG. 4 is a schematic representation of different ways of arranging the phases relative to a reference part.

FIG. 5 is a schematic representation of the conventional structure of a homopolar rotor machine, where a coplanar tetrapolar multiphase stator is placed around a rotor separated into two angularly offset half-rotors.

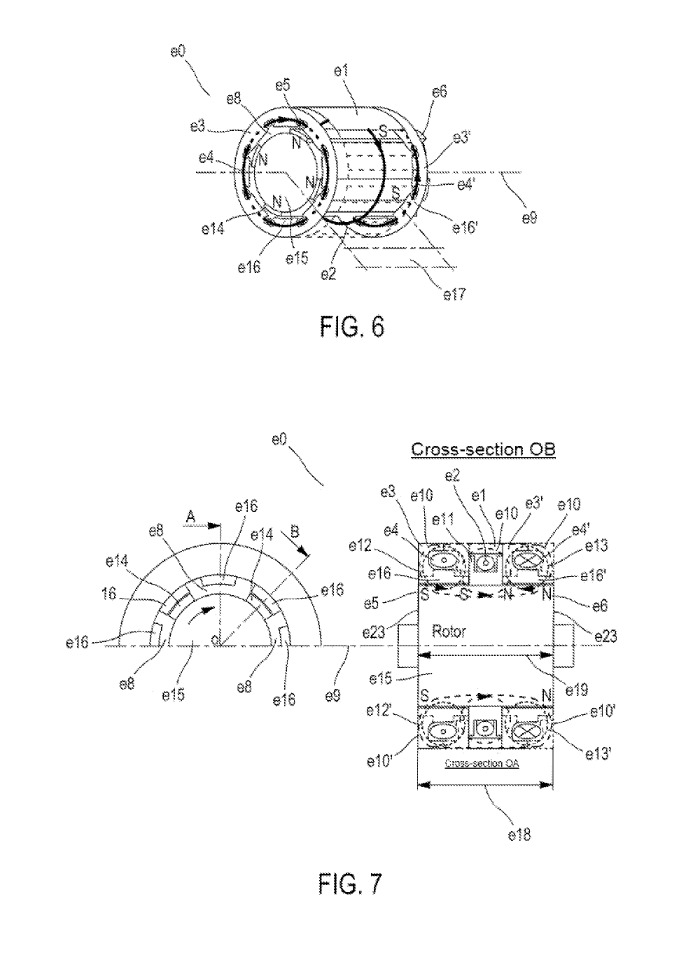

FIGS. 6 and 7 are schematic representations of the general structure of the double homopolar machine according to the invention, in an embodiment corresponding to one double homopolar single-phase alternating machine.

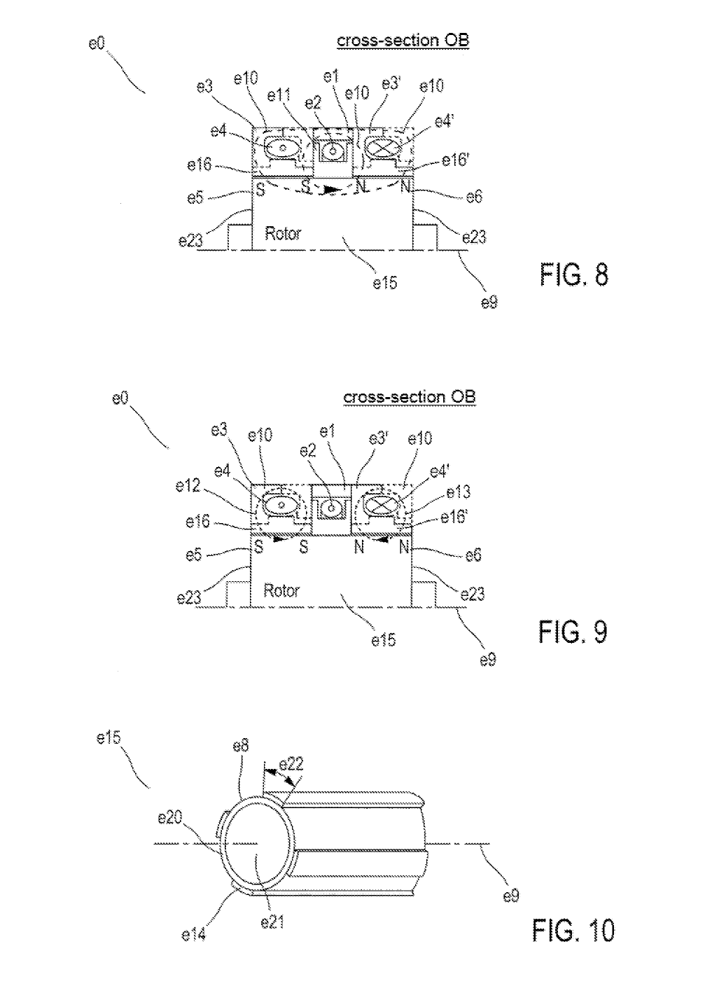

FIG. 8 represents the path of the rotor flux in cross-section OB, in the absence of current in the stator coils of the double homopolar machine according to the invention.

FIG. 9 represents the path of the two stator fluxes in cross-section OB, in the absence of current in the rotor excitation coil of the double homopolar machine according to the invention.

FIG. 10 is a schematic representation of various possible variants of the rotor of the double homopolar machine according to the invention.

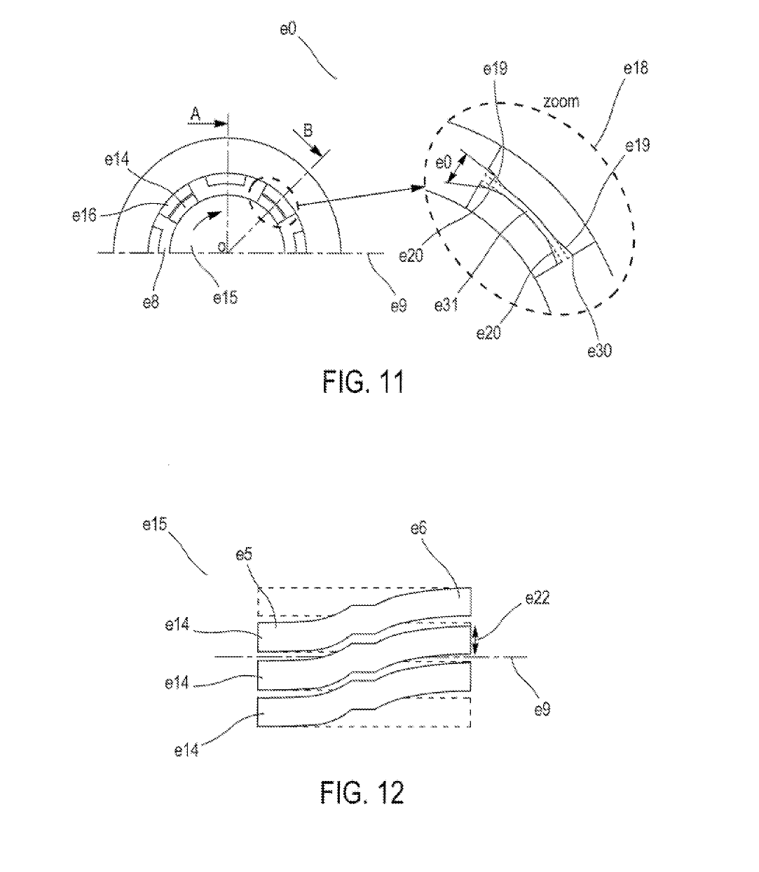

FIG. 11 is a schematic representation of an embodiment of the radial shape of the stator tooth and/or of the rotor tooth.

FIG. 12 is a schematic representation of an embodiment of the rotor, in which the poles are twisted so that each of the ends are angularly shifted by an electrical half-turn.

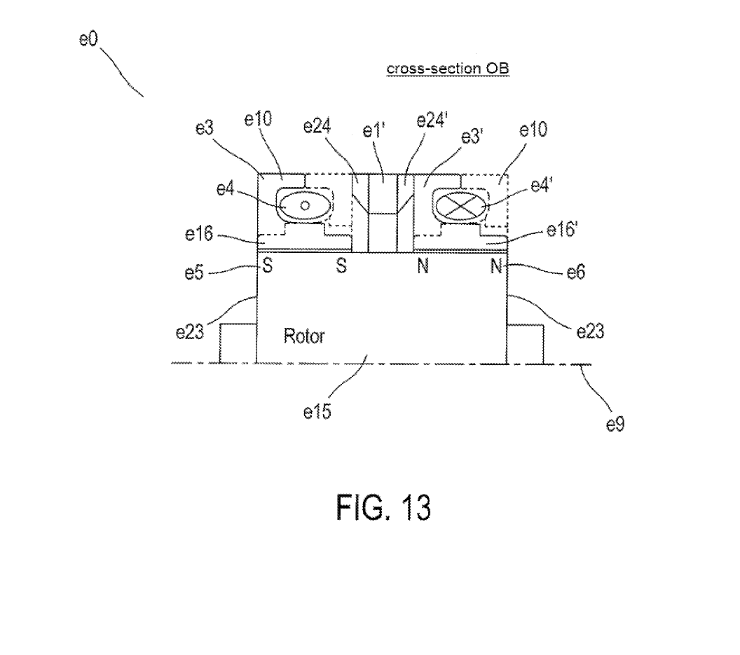

FIG. 13 is a schematic representation of the double homopolar machine along axis OB.

FIGS. 6 and 7 represent the general structure e0 of the double homopolar machine that is the object of the invention, in an embodiment corresponding to one double homopolar single-phase alternating machine e0.

Two phases of a simple homopolar machine e3 and e3′ are aligned concentrically on a same axis of rotation e9, such that their teeth e16/e16′ are collinear in the same radial plane e17. Said phases e3 and e3′ are separated by a ferromagnetic flux return part e1 that is substantially annular in shape, said part e1 being substantially centered on the same axis of rotation e9 as said phases e3 and e3′.

The assembly formed by the phases e3 and e3′ and the flux return part e1 surrounds a ferromagnetic rotor e15 which is substantially centered on the same axis of rotation e9. Said ferromagnetic rotor e15 has as many projecting poles e14 as there are pairs of teeth e16/e16′. This arrangement results in empty space e8 between each projecting pole e14 which opposes, perpendicular to said empty space e8, the radial circulation in the gap of the magnetic flux formed by the meeting of e10 and e12 on side e5 and by the meeting of e10 and e13 on side e6. Said ferromagnetic rotor e15 has an axial length substantially equal to that of the group formed by the two simple homopolar machine phases e3 and e3′, including the inter-phase part e1. Said ferromagnetic rotor e15 is substantially aligned axially with the assembly formed by the two simple homopolar machine phases e3 and e3′, including the inter-phase part e1.

The optimum length and the relative dimensions of each tooth e16/e16′, known to a person skilled in the art for a simple homopolar machine as described above, can be transposed to the machine that is the object of the present invention. The general rules, known to a person skilled in the art, for sizing synchronous electrical rotating machines, particularly simple homopolar machines, apply to the machine of the invention. The optimal angular length e22, as represented in FIG. 10, is substantially equal to two-thirds of the polar electrical length, i.e. mechanically it is two thirds of 360° divided by the number of teeth e16/e16′ of the complete machine.

Phases e3 and e3′ are substantially identical, aside from the opposite directions of their coil e4 and e4′ connections, such that the magnetic fluxes e12 and e13 specific to each of said phases e3 and e3′ flow symmetrically in the air gap.

The homopolar rotor excitation coil e2 generates a homopolar magnetic flux e10 which flows via the air gap, the rotor e15, phases e3 and e3′, and the magnetic flux return part e1. Said rotor magnetic flux is added on side e5 to that emitted by phase e3, and on side e6 opposes that emitted by phase e3′. There is a resulting addition of the corresponding electromagnetic interaction forces at these two sides e5 and e6 of the machine. Said magnetic flux e10 is guided in the stator by the ferromagnetic flux return part e1.

In order to better define the roles of each of the component parts of the machine of the invention, FIG. 8 represents the path, in the cross-section OB, of the only rotor flux e10, in the absence of currents in the stator coils e4 and e4′. Said rotor flux e10 flows radially at the airgap separating the rotor e15 from the phases e3 and e3′, on each side of the stator coils e4 and e4′. In the convention adopted in FIG. 8, said rotor flux e10 enters the rotor on side e5, denoted S, and exits the rotor on side e6, denoted N.

In order to better define the roles of each of the component parts of the machine of the invention, FIG. 9 represents the path, in the cross-section OB, of the two stator fluxes e12 and e13, in the absence of currents in the rotor excitation coil e2. The stator flux e12 flows radially e5 at the air gap separating the rotor e15 from the phase e3, encircling the stator coil e4 but without passing through the flux return part e1.

The stator flux e13 circulates radially e6 at the air gap separating the rotor e15 from the phase e3′, encircling the stator coil e4′ but without passing through the flux return part e1.

Considering the flow of the magnetic flux where a tooth e16 is facing a recess e8, as is shown in the cross-section OA in the lower portion of FIG. 7, it is apparent that the increase in the air gap magnetic reluctance produces a considerable attenuation of the magnetic flux e10′ generated by the coil e2, as well as the magnetic fluxes e12′ and e13′ generated by the phases e3 and e3′. If the space e8 had been filled by a tooth e16, the interaction between the magnetic fluxes e10, e12 and e13 would then have generated a magnetic interaction force opposing that produced at the projecting pole e14, visible in the cross-section OB in the upper portion of FIG. 7. It is therefore apparent that it is the elimination of one pole e14 out of two in the rotor which allows the mean drive torque generated by the machine to be positive.

FIG. 10 shows various possible alternative embodiments of the rotor e15, breaking it down into three fundamental elements: the projecting poles e14, a first ring e20, and an internal cylinder e21. The projecting poles e14 must be made of a ferromagnetic material because they carry the magnetic flux e10 from the rotor.

In a first embodiment, the ring e20 and the cylinder e21 can be made of the same material as the projecting poles e14, forming a single part or multiple different parts. All possible combinations are allowed, according to the known prior art.

In another embodiment, the ring e20 and/or the cylinder e21 can be made of a non-ferromagnetic material, but the projecting poles e14 are still made of a ferromagnetic material.

In another embodiment, other rings of any material can be used in the construction of the rotor, placed between the ring e20 and the disk e21.

The projecting poles e14 can be made of a material from the following non-exhaustive list: solid steel, pressed or sintered iron powder, pressed and assembled sheet metal held together by punching or welding, etc.

The magnetic circuits of phases e3 and e3′ can be made of a material from the following non-exhaustive list: pressed iron powder, pressed and assembled sheet metal held together by punching or welding, etc.

The ring e20 and the cylinder e21 can be made of a material from the following non-exhaustive list: sold steel, pressed iron powder, pressed and assembled sheet metal held together by punching or welding, plastic material formed by injection or machining, aluminum formed by injection or machining, etc.

In one ingenious embodiment, the rotor e15 is formed of a single part which integrates means for maintaining rotation, the cylinder e21, the ring e20, and the poles e14.

FIG. 12 represents a clever embodiment of the rotor e15, in which the poles e14 are twisted so that each of the ends e5 and e6 are angularly offset by an electrical half-turn, i.e. a polar pitch, which corresponds to the distance between the axes of symmetry of the poles e14. In said embodiment, the stator coils e4 and e4′ are then phase connected, in order to emit magnetic fluxes e12 and e13 in phase.

The shape of the teeth e16 and the poles e14 viewed in a cylindrical plane at the air gap does not necessarily define a constant air gap: they may have any other shape such as semi-annular, elliptical, semi-elliptical, rounded, circular, or semi-circular, a person skilled in the art being able to choose the shape according to circumstances.

In a multiphase embodiment of the machine of the invention, the number of phases being greater than or equal to one, the machine of the invention comprises at least as many elementary machines e0 each forming a single-phase machine as there are external electrical phases. In this multiphase arrangement, all these single-phase machines e0 are aligned along the axis e9 and are regularly offset by an electrical angle substantially equal to a complete turn (360°) divided by the number of external electrical phases divided by the number of rotor poles e14.

In one particular embodiment of this multiphase machine, each external electrical phase comprises at least two elementary machines e0 axially juxtaposed or distanced and separated by one or more other elementary machines e0.

In one multiphase embodiment, the positioning parts that separate the single-phase machines e0 can advantageously use the same techniques as those described in patent FR 10 01805, functionally considering the groups e0 as the complete simple homopolar phases described in said patent. Said positioning parts can be resin injected on side faces e23 of a plane perpendicular to the axis e9 of the partially or completely assembled single-phase machine e0.

In one multiphase embodiment, the relative positioning between the single-phase machines e0 can be fixed using pins and holes arranged in the side faces e23 of a plane perpendicular to the axis e9 of the single-phase machine e0. In another multiphase embodiment, the angular positioning means can be implemented using undulations or complementary shapes arranged in said side faces e23 of a plane perpendicular to the axis e9 in the monophase machine e0.

In one particular embodiment, the rotor excitation coil e2 is created by winding conductive wire around an electrically and magnetically insulating mandrel e11. Said mandrel is advantageously used to position rotationally the two phases e3 and e3′ so that their respective teeth are aligned in the same radial plane. Said alignment can use notches in radial faces of the mandrel e11 and/or of the phases e3 and e3′, or undulations on said faces, or holes receiving centering pins, or any other method of retention.

In one particular embodiment, the rotor excitation coil e2 is created on a support which does not contribute to fixing the angular positioning between the phases e3/e3′ and the flux return part e1, in which case said angular positioning can be achieved in said parts e1/e3/e3′ by undulation or crenellation or any other method, as described in patent FR 10 01805.

In one particular embodiment, the rotor excitation coil e2 and the coils e4/e4′ only comprise a few turns, made with wire that is preferably rigid, and insulated by an insulating ceramic.

In one particular embodiment the rotor coil e2, and the coils e4/e4′, can be made using a wire having a cross-section non-exclusively belonging to the following list: square, rectangular, flattened, hexagonal, octagonal, polygonal, elliptical, round, etc.

In one particular embodiment the rotor coil e2 and/or the stator coils e4/e4′ comprise at least two separate coils assembled together, in an axial and/or radial plane, said coils being connected to each other serially and/or in parallel, or in zig-zag mode.

The part which fixes the axial positioning between two phases e3 and e3′ of a same single-phase machine e0 can be created by adopting the same techniques as those described in patent FR 10 01805, functionally considering the respective radial joining planes of a phase e3 or e3′ and the face opposite said phase of the winding mandrel e11.

In one particular embodiment, the stator phases e3/e3′ and/or the rotor coil e2 are encapsulated by a resin or a ceramic deposited in powder form then baked, with their magnetic circuit, separately or when assembled in the motor.

In one particular embodiment, the ferromagnetic material forming the phases e3/e3′ comprises any of the material among the following non-exhaustive list: compressed, sintered, or pressed iron powder, sheet metal cut, punched or riveted or tightly maintained by an external connection, ferrite, etc.

In one particular embodiment the ferromagnetic material forming the flux return part e1 and/or the flux return part(s) e1′ comprises any one of the materials in the following non-exhaustive list: compressed, sintered, or pressed iron powder, sheet metal that is cut, and punched or riveted or tightly maintained by an external connection, ferrite, solid steel that is machined or molded, etc.

In one particular embodiment, the rotor coil e2 is eliminated and the flux return part e1 is replaced by at least one magnet e1′ that is substantially annular in shape, substantially magnetized along the axis e9. Said annular magnet e1′ then replaces the flux return part e1. In another particular embodiment of the same constructive arrangement, the annular magnet e1′ is clasped between one or two ferromagnetic parts e24/e24′ of a substantially trapezoidal, annular, or elliptical shape, which allow concentrating the flux issuing from the annular magnet e1′, said parts e24/e24′ having the shape of a truncated cone with the largest side against the magnet e1′.

The shape of the stator tooth and the arrangements described in patent FR 10 01807 apply to the design of the single-phase double homopolar machine e0.

FIG. 11 represents an enlarged view e18 of an ingenious embodiment of the radial form of the stator tooth e16/e16′ and/or of the rotor tooth e14, giving the air gap magnetomotive force a wave shape that is substantially sinusoid, depending on its electrical angle.

The stator tooth e16 comprises, at each of its angular ends, a radial recess e19 which is intended to adjust the value of the air gap e0 radially. The radial shape of said radial recesses e19 is contained within the following non-exhaustive list: linear in the form of bevels, rounded, elliptical, rounded to give the local air gap e0 a value substantially indexed to the inverse cosine of the electrical angle, for which the origin is on the axis of symmetry of the tooth e16.

The rotor pole e14 comprises, at each of its angular ends, a radial recess e20 which is intended to adjust the value of the air gap e0 radially. The radial shape of said radial recesses e20 is within the following non-exhaustive list: linear in the form of bevels, rounded, elliptical, rounded to give the local air gap e0 a value substantially indexed to the inverse cosine of the electrical angle, for which the origin is on the axis of symmetry of the pole e16.

Advantageously, the air gap e0 at the side e30 of the tooth e19/e20 is twice the air gap at the center e31 of the teeth.

One or both of the arrangements e20 and e19 can be used in the double homopolar machine e0.

The construction arrangements described in patent FR 10 01806 for forming a multiphase machine also apply to the design of the single-phase double homopolar machine e0.

In one particular embodiment, a same single-phase double homopolar machine can be implemented by axially stacking several complete machines e0 to form one phase. Said machines e0 are then substantially fixed in their angular positions and the rotor e15 has an axial length substantially equal to the axial length of the set of machines e0 forming said single-phase machine.

In one particular embodiment, the rotor coil e2 can be powered with alternating current, at an electrical phase and frequency equal or unequal to the power frequency of the stator coils e4/e4′.

In one particular embodiment, the external shape of phases e3/e3′ and of the flux return part e1 does not fit into a cylindrical shape, but into another shape which may be rectangular, elliptical, polygonal, or some other shape, a person skilled in the art knowing how to adapt the implementation of the machine to this particular construction arrangement.

Note in particular that the invention has been described in a direct topology, corresponding to a machine structure of type f4 which comprises, among other things, an internal rotor e15, and two external phases e4 tightly clasping a coil e2 and connected to each other by a flux return part e1. In another embodiment, the reversed type f5, said machine e0 comprises, among other things, an external rotor e15, and two internal phases d4 clasping a coil e2 and connected to each other by an internal return flux part e1. The transposition from the description set forth in this document for machine structure f4 to machine structure f5 is achieved by performing a symmetric radial transformation around the air gap of the component parts of the phases d4, particularly on the teeth e16/e16′ which then become external to the respective phases e3/e3′, as well as on the poles e14 which become internal to the rotor e15; a person skilled in the art would be able to perform this transposition without difficulty.

All the elements presented in this invention can be extended to other static or rotating electrical machines comprising any number of electrical phases and electromagnetic poles. The present invention is not limited to the example embodiments described, but extends to any modification and to any variant obvious to a person skilled in the art, while remaining within the scope of the protection defined in the attached claims.

1. Homopolar electrical machine,
characterized in that it is double (e0) in structure, its rotor and its stator being simultaneously homopolar.

2. Machine according to claim 1,
wherein it comprises a stack of pairs of simple homopolar stators (b10/d4) forming single-phase elementary machines (f4), or (f5) in an inverted version, said elementary machines being powered with alternating current; the rotor (e15) is common to all these stators and is passive, meaning it consists wholly or partially of ferromagnetic material.

3. Machine according to claim 1,
wherein two simple homopolar machine phases (e3) and (e3′) are aligned on a same axis of rotation (e9), such that their teeth (e16/e16′) are collinear in the same radial plane (e17).

4. Machine according to claim 3,
wherein the phases (e3) and (e3′) are separated by a ferromagnetic flux return part (e1) that is substantially annular in shape, said part (e1) being substantially centered on the same axis of rotation (e9) as said phases (e3) and (e3′).

5. Machine according to claim 3,
wherein the assembly formed by the phases (e3) and (e3′) and the flux return part (e1) surrounds a ferromagnetic rotor (e15) which is substantially centered on the same axis of rotation (e9), said ferromagnetic rotor (e15) comprising as many projecting poles (e14) as there are pairs of teeth (e16/e16′) on the phases.

6. Machine according to claim 5,
wherein said ferromagnetic rotor (e15) has an axial length substantially equal to that of the group formed by the two simple homopolar machine phases (e3) and (e3′).

7. Machine according to claim 5,
wherein said ferromagnetic rotor (e15) is substantially aligned axially with the assembly formed by the two simple homopolar machine phases (e3) and (e3′).

8. Machine according to claim 5,
wherein it comprises a homopolar rotor excitation coil (e2) provided for generating a homopolar magnetic flux (e10), which flows via the air gap, the rotor (e15), the phases (e3) and (e3′), and the magnetic flux return part (e1), said rotor magnetic flux being adding on side (e5) to that emitted by the phase (e3), and on side (e6) opposes that emitted by the phase (e3′), such that there is a resulting addition of the corresponding electromagnetic interaction forces at these two sides (e5) and (e6) of the machine, said magnetic flux (e10) being guided in the stator by the ferromagnetic flux return part (e1).

9. Machine according to claim 2,
wherein the rotor (e15) comprises three elements: the projecting poles (e14), a first ring (e20), and an internal cylinder (e21), said projecting poles (e14) being made of a ferromagnetic material so that they carry the rotor magnetic flux (e10).

10. Machine according to claim 9,
wherein the ring (e20) and the disk (e21) are made of the same material as the projecting poles (E14), forming a single part or multiple different parts.

11. Machine according to claim 9,
wherein the ring (e20) and/or the cylinder (e21) are made of a non-ferromagnetic material, the projecting poles (e14) being made of a ferromagnetic material.

12. Machine according to claim 2,
wherein the rotor (e15) is formed of a single part which integrates means for maintaining rotation, the cylinder (e21), the ring (e20), and the poles (e14).

13. Machine according to claim 9,
wherein the poles (e14) of the rotor (e15) are twisted so that each of the ends (e5) and (e6) are angularly offset by an electrical half-turn, meaning by a polar pitch, said polar pitch corresponding to the distance between the axes of symmetry of the poles (e14), the stator coils (e4) and (e4′) being phase connected, such that they emit magnetic fluxes (e12) and (e13) in phase.

14. Machine according to claim 9,
wherein it comprises at least one phase and thus comprises at least as many elementary machines (e0) each forming a single-phase machine as there are external electrical phases, such that in this multiphase arrangement, all these single-phase machines (e0) are aligned along the axis (e9) and are regularly offset by an electrical angle substantially equal to a complete turn (360°), divided by the number of electrical phases, divided by the number of rotor poles (e14).

15. Machine according to claim 10,
wherein each external electrical phase comprises at least two elementary machines (e0) axially juxtaposed or distanced and separated by one or more other elementary machines (e0).

16. Machine according to claim 14,
wherein the spacing between the single-phase machines (e0) is created using pins and holes arranged in side faces (e23) of a plane perpendicular to the axis (e9) of the single-phase machine (e0); the angular positioning means being implemented using complementary undulations arranged in said side faces (e23) of said plane (e9).

17. Machine according to claim 3,
wherein it comprises a rotor excitation coil (e2) created by winding conductive wire around an electrically and magnetically insulating mandrel (e11); said mandrel being used to position rotationally the two phases (e3) and (e3′) so that their respective teeth are aligned in the same radial plane; said alignment is achieved using either notches arranged in radial faces of said mandrel (e11) and/or of the phases (e3) and (e3′), or undulations on said faces, or holes receiving centering pins, or any other positioning method.

18. Machine according to claim 3,
wherein it comprises a rotor excitation coil (e2), created on a support which does not contribute to fixing the angular positioning between the phases (e3)/(e3′) and the flux return part (e1).

19. Machine according to claim 3,
wherein the rotor coil (e2) and/or the stator coils (e4/e4′) comprises/comprise at least two separate coils assembled together, in an axial and/or radial plane, said coils being connected to each other serially and/or in parallel.

20. Machine according to claim 3,
wherein the stator phases (e3/e3′) and/or the rotor coil (e2) are encapsulated by a resin or a ceramic with their magnetic circuit, separately or when assembled in the motor.

21. Machine according to claim 3,
wherein it does not comprise a rotor coil (e2) and comprises at least one magnet (e1′) that is annular in shape, substantially magnetized along the axis (e9); said annular magnet (e1′) preferably being clasped between one or two ferromagnetic parts (e24/e24′) of a substantially trapezoidal, annular, or elliptical shape, which allow concentrating the flux issuing from said annular magnet (e1′), said parts (e24/e24′) substantially having the shape of a truncated cone, with the largest side against the magnet (e1′).

22. Machine according to claim 3,
wherein each stator tooth (e16) comprises, at each of its angular ends, a radial recess (e19) which is intended to adjust the value of the air gap (e0) radially; the radial recesses (e19) having a radial shape which allows giving the local air gap (e0) a value substantially indexed to the inverse cosine of the electrical angle, for which the origin is on the axis of symmetry of the tooth (e16).

23. Machine according to claim 3,
wherein each rotor pole (e14) comprises, at each of its angular ends, a radial recess (e20) which is intended to adjust the value of the air gap (e0) radially; the radial recesses (e19) having a radial shape which allows giving the local air gap (e0) a value substantially indexed to the inverse cosine of the electrical angle, for which the origin is on the axis of symmetry of the pole (e16).

24. Machine according to claim 2,
wherein it is implemented by axially stacking several complete machines (e0) to form one phase, said machines (e0) then being substantially fixed in their angular positions and the rotor (e15) having an axial length substantially equal to the axial length of the set of machines (e0) forming said single-phase machine.

25. Machine according to claim 13,
wherein the rotor coil (e2) is powered with alternating current, at an electrical phase and frequency equal or unequal to the power frequency of the stator coils (e4/e4′).
